(19) United States
(12) Patent Application Publication
(10) Pub. No.: US 2017/0104756 A1
(43) Pub. Date: Apr. 13, 2017

(54) Detection, protection and transparent encryption/tokenization/masking/redaction/blocking of sensitive data and transactions in web and enterprise applications

(71) Applicant: Secupi Security Solutions Ltd, Ramat Efal, IL (US)

(72) Inventors: Alon ROSENTHAL, Ramat Efal (IL); Dotan ADLER, Raanana (IL)

(21) Appl. No.: 15/292,177

(22) Filed: Oct. 13, 2016

Related U.S. Application Data
(60) Provisional application No. 62/240,795, filed on Oct. 13, 2015.

(51) Int. Cl. H04L 29/06

(52) U.S. Cl. CPC H04L 63/10; H04L 63/20; H04L 63/0428

(57) ABSTRACT

A plurality of users connect to an application sending requests over a transport and receiving responses from an application that contain sensitive data. For each user request, the application runs one or more data requests and commands to various data sources or other information systems which return the sensitive data. The application then processes the data and returns is to the user as is or processed based on some business logic. The application includes a run-time environment—where the application logic is executed.

### FIELD OF THE PRESENT INVENTION

The present invention relates to a process of detecting, controlling and protecting sensitive information across web and enterprise applications (using encryption, tokenization, masking, redaction or blocking).

### BACKGROUND OF THE PRESENT INVENTION

Today, many large organizations maintain thousands of sensitive applications that are exposed on a daily basis to thousands of end-users, partners, clients, part time workforce, new hires and resignations. With sensitive data such as personal information, medical information and sensitive financial data being exfiltrated by malicious insiders and hackers that hijack user identities—organizations must be able to detect sensitive data exposure by malicious insiders and hackers in real-time. In addition, increasing regulations and industry standards require fine-grained audit of “who” accessed “what”, “when” and “where”.

Without wishing to be limited in any way, the term web or enterprise applications often relate to a situation in which a plurality of users and program interfaces connect to an application sending requests and receiving responses from the application that contains sensitive information. For each user request, the application run one or more data requests and commands to various other applications or data sources which return the sensitive data. The application includes a run-time environment where the application logic is executed; and calls are made to various other application servers or data sources (such as a database, big-data repositories file, application program interface (API) or an Enterprise Application Integration solution—EAI) where sensitive information is stored, accessed by the application.

The challenge is that these applications are highly complex, thus requiring tedious human effort to monitor, classify and detect suspicious malicious events and protection of the data becomes an impossible task. Most commonly, application logs or Web Application Firewalls (WAF) cannot get information about who accessed which sensitive and/or regulated information in the application, while both Database Activity Monitoring solutions (DAM) and native database audit are not acceptable performance wise and do not give accurate enough information to act on (like the identity of the end user that is hidden by layers of applications, and the use of database-connection pools—having the database blind to the end user context). Therefore, there is a need for a system for fast and accurate detection, and monitoring, of sensitive data in a transparent, generic, resource-lean and context-rich scalable way.

### SUMMARY

A plurality of users connect to an application sending requests over a network and receiving responses from an application that contain sensitive data or apply a command to manipulate sensitive data using an Application Program Interface (API call). For each user/API request, the application runs one or more data requests and commands to various data sources or other information systems which return the sensitive data. The application then processes the data and returns it to the user as is or processed based on some business logic. The application includes a run-time environment—where the application logic is executed.

The existing approach of monitoring applications uses network Sniffers (Web Application Firewalls—WAF. Database Access Monitors—DAM, network proxies, application logs, full database audits and database agents and the like). The problems of these existing approach include the fact that all of them lack context—only monitor incoming network traffic, or data only so they are all blind to encrypted network packets, application caches, and are even blind to stored procedure calls and data-source result sets (they only see unformatted data packets traveling over the network—which they try to parse, with limited accuracy).

Web Application Firewalls (WAF) that are installed between the clients and the web servers are blind to the data context (as they see only returning result packets and not the structured database queries). WAF solutions lack the ability to identify which response network packets contain sensitive data that needs to be monitored, and which response network packets not within the endless flood of packets. In addition, the returning data stream packets are unstructured and highly dependent on the client technology.

Database Access Monitoring (DAM) installed as an in-line proxy or in sniffer mode detect and audit the SQL request stream as well as the result set retuned to each query, but they are blind to the user context that is hidden within the application server domain and not exposed to the database connections that use standard application connection pools (connecting application requests to a data source using a pool of connections with a single generic database user), and not the originating end-user credentials, and thus cannot provide detection and monitoring of sensitive data flows.

Database full audits record everything done in the database, and hence create a lot of clutter, impose a huge performance penalty, plus they lack the user information that is hidden behind the application layer.

In addition, in cases where the organization has implemented network encryption, WAF and DAM become totally blind unless they open the encryption which adds a potential security exploit.

Application logs provide mere partial information, logging only data inserts, updates and deletes, and not data reads, missing all the important information about users accessing data.

### BRIEF DESCRIPTION OF THE DRAWINGS

The preferred embodiments of the present invention will hereinafter be described in conjunction with the appended drawings, provided to illustrate and not to limit the present invention, wherein like designations denote like elements, and in which:

FIG. 1A shows an exemplary, non-limiting system which features an application user 106 communicating with an application server 100, which based on the user request, sends a data request to a data source 108.

FIGS. 1B and 1C show other embodiments of an exemplary, non-limiting system of the present invention.

FIG. 2 shows an exemplary, illustrative non-limiting system 200 for constructing and injecting injectable code to provide real-time monitoring capabilities.

FIG. 3A shows an exemplary, non-limiting illustrative flow in which the central policy manager defines policies in one or more of the request data flow stages, that when translated into code and injected into the application server operated applications, detect user interactions with the data.

FIG. 3B shows a similar flow to FIG. 3A except that the application server itself performs the detection and determining whether or not to audit, permit or block the interactions.

FIG. 3C is another exemplary flow with regard to detection of user application interactions and either permitting or blocking such interactions.

FIG. 4 is an exemplary, illustrative, non-limiting flow which shows the details of the flow of FIG. 3C in greater detail.

FIG. 5 shows the flow of each run time program that is attached to one of the application programs on the application server in the run time environment.

FIG. 6 shows an illustrative, non-limiting example of a policy tree.

FIG. 7 shows a non-limiting example of how various stages may lead to policy trees being generated which in turn may optionally be used to create a policy code generator.

FIG. 8A shows a non-limiting example of a system featuring a run-time environment.

FIG. 8B shows the application run-time environment of FIG. 8A as previously described in more detail.

FIG. 8C, again, shows the application run-time environment with the central management server and, which in this case, also includes an optional data logger 826.

FIG. 9 shows a non-limiting exemplary display of the results of the data exfiltration analysis.

FIG. 10 shows a non-limiting, exemplary method for determining the “4V” model score.

### DETAILED DESCRIPTION OF THE PRESENT INVENTION

While various embodiments of the present invention have been illustrated and described, it will be clear that the present invention is not limited to these embodiments only. Numerous modifications, changes, variations, substitutions and equivalents will be apparent to those skilled in the art without departing from the spirit and scope of the present invention.

The term application refers to any program software code such as but not limited to a single or multiple run-time programs deployed on multiple application servers and/or a web server in which an end-user or another application program interface (API) or a scheduled request is sending a request to the application, that is sending a request to receive data from any source (database, file, data service, micro-service, application program interface—API, or an Enterprise Application Integration EAI hub) or apply a transaction.

An application may optionally be operated by any computational device, including but not limited to a single server, a Virtual Server, a laptop, or a mobile device, or on a cluster of such computational devices.

The detection system as described herein may optionally include a computer program code that is injected into a specific application run-time program code. The injected computer program code includes the ability to track a user-session thread (referred as “session tracking id”) of some, or all user request from initiation (for example, injecting a code to the application servlet program that processes incoming user requests) to completion (for example, injecting a code to the application JDBC program that sends and receives that data source requests into a relational database), linking a single request across the request execution stages (referred to as “lineage”) both in a single application run-time program or across multiple application run-time programs. The injected computer program code includes the ability to collect, analyze, replace or delete all request context and variables such as system information (environment, time), user information, application information, request information (e.g. user computer IP address, requested URL, request headers, cookies etc.), and data information (e.g. all parsed SQL requests and result set structure, titles and values, outbound output http requests and responses, etc.).

According to at least some embodiments, the present invention can replace or delete one or more (or even all) request context and variables in one or more (or even all) instrumented stages of the run-time program. Replacing or deleting such context and/or variable(s) optionally comprises masking a value, which optionally includes providing a dynamic mask, and/or to perform one of the following: encrypt/decrypt, tokenize/detokenize, hide, redact, delay or block the sensitive-data-flows and high value transactions of end-users and/or external program interface (API calls).

The present invention, in at least some embodiments, provides a computer system that utilizes injected run-time code into two or more relevant application run-time programs. The injected code is executed before and/or after sensitive user requests (such as a URI request) and data requests (such as a SQL “Select” request) are executed in order to audit and monitor all data flows and high-value transaction, but can also include adding injected run-time code into other application run-time programs.

The data collected by the injected programs can include the end-user name, the user request, the user and/or data request variables, the data request, the result set returned from the data source to the application when exists, and/or the user response when exists.

The invention describes a computer system that can inject run-time code into relevant application run-time programs using instrumentation on Java, .Net, Node.js, PHP and other programming languages that employ a virtual machine, as well as by adding code to the run-time program by changing the run-time code of the application code, source code changes performed by a programmer and/or automatically by scanning the application code and inserting new code in the relevant places, done for example on C or C++ DLLs and Shared Objects binary program code.

The injected code is executed before and/or after sensitive data requests are performed in order to detect, audit and monitor data flows.

For example, this can be done by using a Post-Build process that scans the source or binary code during development time and injects the relevant code into the source or binary, before it is being deployed OR it can be done as a post build process, where a virtual machine transforms/instruments the binary code before it is being loaded into memory and before it is being executed by the virtual machine, OR by injecting code into application files in the filesystem (for example DLLs, Shared Objects, object code) before it is being loaded and executed at runtime, or by changing the source code of the application—adding program calls to a central server for sending event context and receiving changes to the variables and code executed by the application.

According to at least some embodiments, the above functions are provided in situations in which program code can be instrumented, as well as on program code that cannot be instrumented—using code changes in the application. For example such changes may optionally be made manually by programmers or automatically by scanning the application code and adding the new code into the claims.

In addition, the detection system as described herein may optionally include a policy engine that can be used by security administrators or can be loaded with policies using a program or an application program interface (API), or by simply import predefined policies.

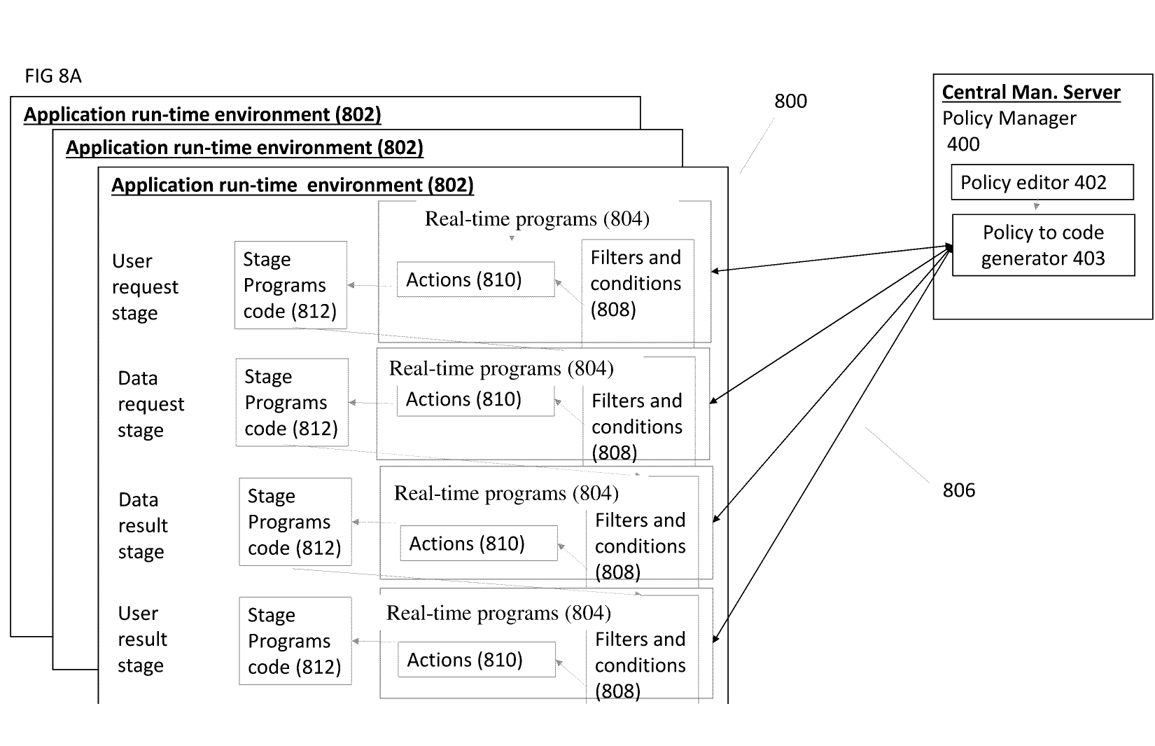

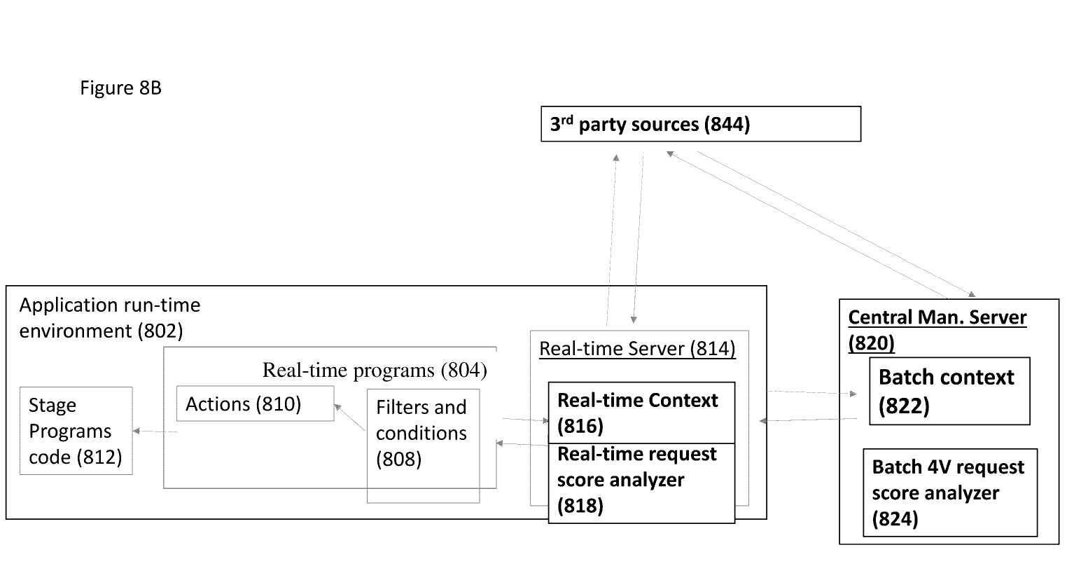

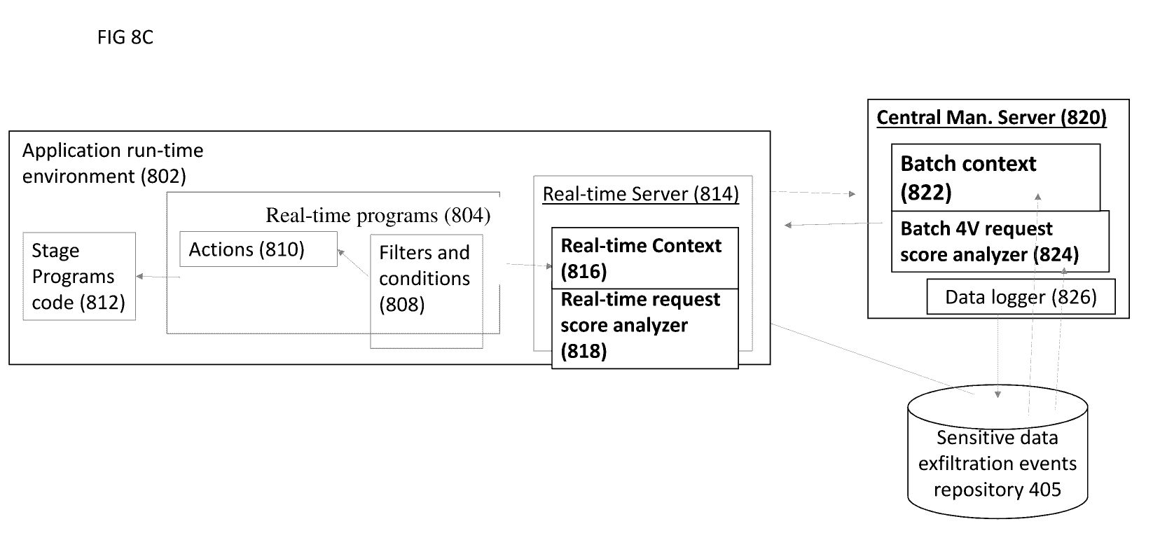

Another unique capability of the system is its ability to transform the policies into run-time program code (for example by using the policy-to-code generator, in FIG. 8A), and inject these new policies into the application run-time programs code, with no need for any application restart or source code changes. The update to the instrumented agent's run-time code is optionally performed every week/day/hour/minute, or based on administrator request or based on the agent time schedule.

The policies can optionally audit, monitor, dynamic mask, encrypt/decrypt, tokenize/detokenize, hide, redact, delay or block the sensitive-data-flows and high value transactions of end-users and/or external program interface (API calls) within the user request, data request, data response from the data source and user response returned to the end-user or application program interface call, as well as possibly on other programs—as specified by the policies.

Applying policies (that is, particular restrictions or functions) in specific application run-time programs as instructed by the policies in advance or dynamically on-demand enables the system to have very wide functional possibilities, while imposing low performance penalties or overhead, and increasing the application security posture in a transparent way.

As described herein, terms such as “user request” and the like are understood to involve actions taken through a user computer (e.g., API call) and/or by a user application.

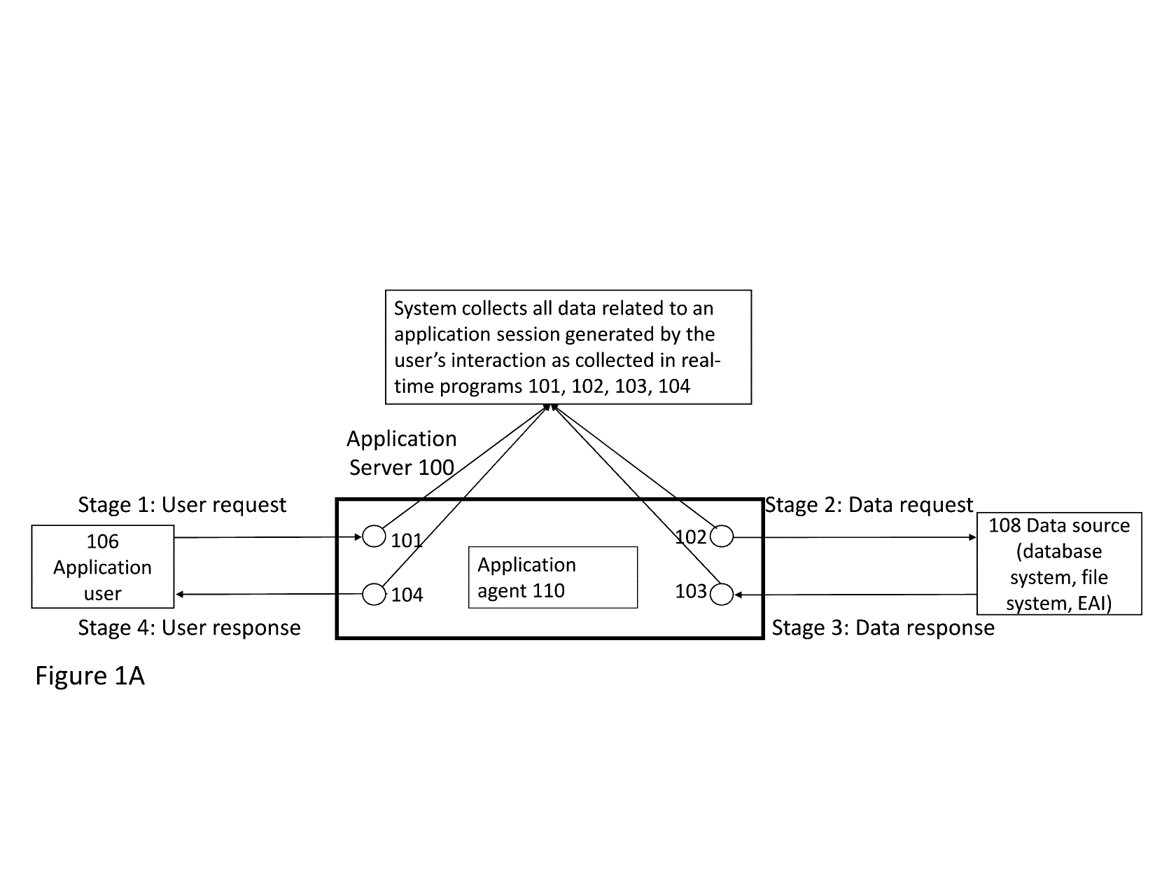

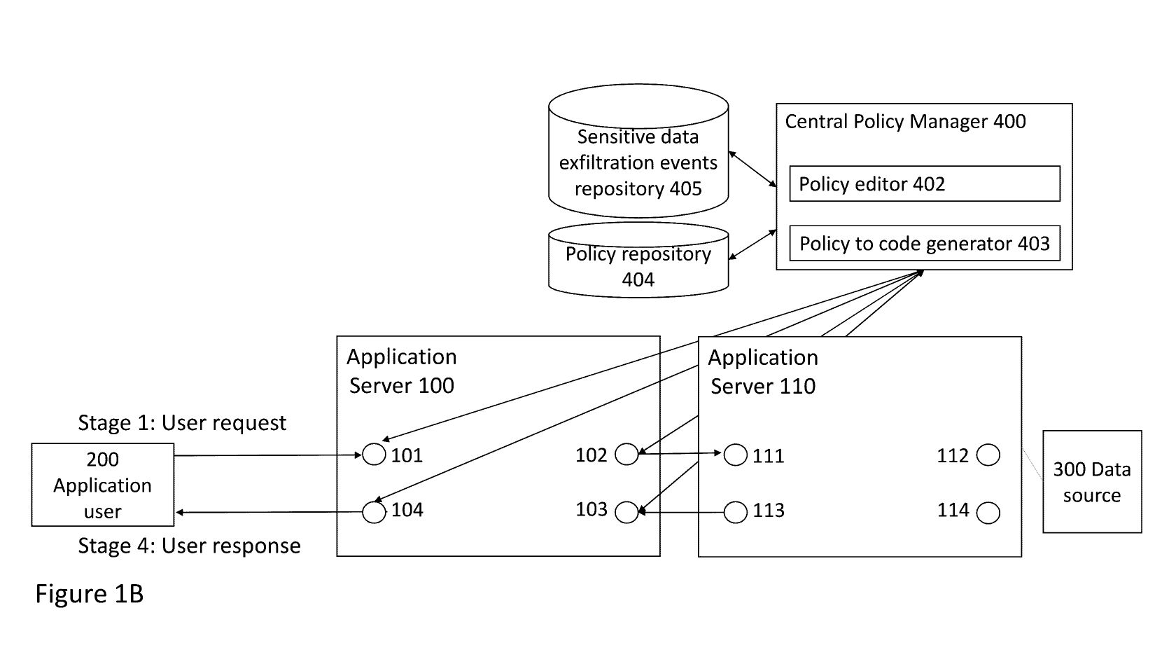

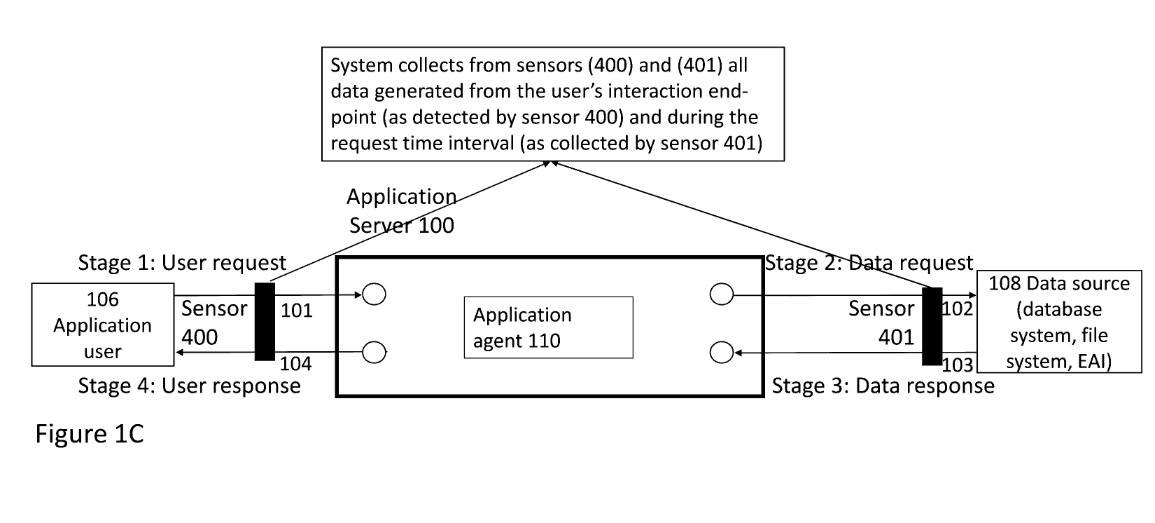

Turning now to the Figures, as shown in FIG. 1A, there is an exemplary, non-limiting system which features an application user 106, operated by a computational device (not shown), communicating with an application server 100, which based on the user request, sends a data request to a data source 108. Data source 108 map should be a database system, file system, EAI, or any other source of sensitive data.

During its typical operation, user application 106 would send a request to the application server 100 for some type of function, which would involve some type of sensitive data processing and/or sensitive data retrievals (and exposures). This would form the user request as shown. Application server 100 then sends data requests to data sources 108 as a result of the user request, in order to retrieve sensitive data or perform the functions or to otherwise satisfy the user request (for example, in an application working with a relational database, the user sends a request in a URL form to an application, the application sends a corresponding data request in a SQL format to the database, such as “select customer_name from table_customer”). Data source 108 then responds to application server with the data responses (in relational database, this is defined as “result set” that is combined from various columns, which some of them might be sensitive)

Application server 100 would then send a response to the user that is to application user 106 (this is commonly referred to as “output”). For the purpose of the present invention, at least in embodiments, application server 100 also features an application agent 110. Application agent 110 collects all data related to the user's interaction as collected in injected real-time programs 101, 102, 103, and 104. The user request processing in the application server 100 is characterized with a specific session tracking id which is unique to the user request, and which is collected by the application agent 110 in addition to other run-time variables and system, user, application, session and request variables from the application or from other programs and Application Programming Interfaces (APIs). The application server agent 110 optionally and preferably collects rich-context on each user request/report/program, from the application run-time program as well as from external sources including but not limited to environment context (such time, date), application context (application name, type), user context (name, role, LDAP attribute, hire date, resignation date), session (IP, geolocation, device, custom variables), request context (type, value, variable value, objects, result set size, result set value, output value). This additional context is used to detect the sensitive data flows from the rest.

Optionally and preferably, application agent 110 may access one or more of the following variables (intended as examples only and not to create a closed list):
a. Client and user information, such as user name, host name, client IP, OS user, geo location, role, LDAP/ActiveDirectory attributes, terminal
b. The request, such as time of request, request type, any of the request parameters
c. The SQL request to the data source, the SQL type (select, update, insert or delete), instance (may be relevant, for example, for clustered environments, to represent an instance on which the execution is taking place), module, schema, objects, columns, owner, application, host, bind variables and any other variables added to the SQL request, request condition, group by, order by and any other part of the SQL request,
d. The result set returned from the data source to the application, including result set headers, column names, values, error message or any type of database response
e. The user response, includes HTML, JSON, XML FILES or a program interface that is returned to the user
f. The user behavior profile, or a peer behavior profile, user status, responsibility and role
g. Environment context, such as request's date and time

Application agent 110 is operated by application (which may also optionally be or a virtual Machine such as JAVA, .NET, PHP and the like) 100 and intercepts requests from user application 106 or from external application programs and other directive communication with data source 108 as described above. This interception is necessary in order to determine which data is sensitive. Real-time programs 101, 102, 103, 104 are preferably executed in-line, more preferably before every application program-code that is handling user requests, such as user agent 106, as well as any application program-code that is interfacing with a data source, such as application server 100 and/or software operating data source 108

Application agent 110 is therefore able to collect and correlate (by identifying and matching the user request session tracking id) the sensitive user and data requests in each one of the run-time programs 101-104, detecting the related flows of sensitive data (referred to as “lineage”). These flows are initiated by a user operating user application 106, followed by the application 100 generating a set of related data-source requests submitted to the data sources 108, followed by the results retuned from the data sources to the application 100, and the application outputs that are returned to the user through user application 106.

That is how the operation of user application 106 and the operation of the application itself and application server 110 correlate to cause sensitive data to be abstracted from or written to data source 108.

Data Flow Monitoring across application servers according to at least some embodiments is now described. When multiple application servers 100 are working in-line to process the user request one after the other, each application with a different session tracking id., the application agent 110 in each application server 100 identifies the requests by adding a unique session remark that identifies the original user request's session tracking id into the communication between the two (or more) application servers. Non-limiting examples include adding an header to the request between the parties in case of http requests, by adding a remark into the Application Program Interface calls (API) or detecting a unique identifier (such as client IP) that is transmitted from one application server to the other or by collecting the variables, session tracking id and time stamp for each request in both application servers and correlate them by comparing their time stamp and request variables. The application server 100 that receives the remark in the communication parses it. These added remarks identify the original user session across different application servers, as the remark is detected and identified by each application agent 110 on each application server 100 respectively.

For example, an application server executes the requests, which then are sent for further processing to a secondary application server or a microservice (Application Server 110 in FIG. 1B) using for example, a web service call or an Application program interface (API) (requests 102-111, and 113 to 103).

Policy to code generator 403 provides multiple sets of injected run-time programs for each application server or microservice instance (Application Server 110 in FIG. 1B). The injected program 102 adds a marker to the requests that are sent from Application Server/microservice 100 to Application Server/microservice 110 by adding a unique ID inserted to the request header or request body or in the request variable or proceeding or following requests.

Another option is to use an existing request identifier (such as source client IP address) that appears in request header or request body that is compared in each one of the injected programs in each one of the application servers 100 and 110.

The unique ID or the unique identifier (such as source client IP address) is received by the injected program code in 111 thus linking the request originated in server 100.

The request information from both injected programs in server 100 and server 110 are sent back to the computer program and/or to the application server 100 injected program code (103) by returning the ID as either the header and or body or in the request variable or proceeding or following requests of the response between application server 110 and application server 100.

FIG. 1C shows another embodiment of an exemplary, non-limiting system of the present invention. In this embodiment, optionally application agent 110 is in application server 100, but additionally or alternatively there is present a sensor 400 which sits between user application 106 and application server 100. Another option is adding a network sensor 401 which sits between application server 100 and data source 108.

Correlating the context regarding a user request event collected in the network sniffer 400 with the context collected by the application agent 110, is performed by adding a unique id. The terms “sniffer” and “sensor” are used interchangeably.

In this instance, application agent 110, or another external software module (not shown) external to application server 100, collects data from sensors for 100 and 401. Such data optionally includes all data generated from the users, from the application, from the interaction of application user 106 as detected by sensor 400 and also as transmitted to or from data source 108 as collected by sensor 401.

Sensor 400 can be either a network sniffer or the sensor can be added to selected user end-points by adding a run-time code to the user response which is sent to the end-point (stage 4) (such as adding a Java script to the HTML output sent to a user end-point device). The run-time code sent to the end-user device is executed on the user device in order to collect mouse movement and key stroke data, or challenge the user identity with additional validation actions, or to perform any other activity on the endpoint.

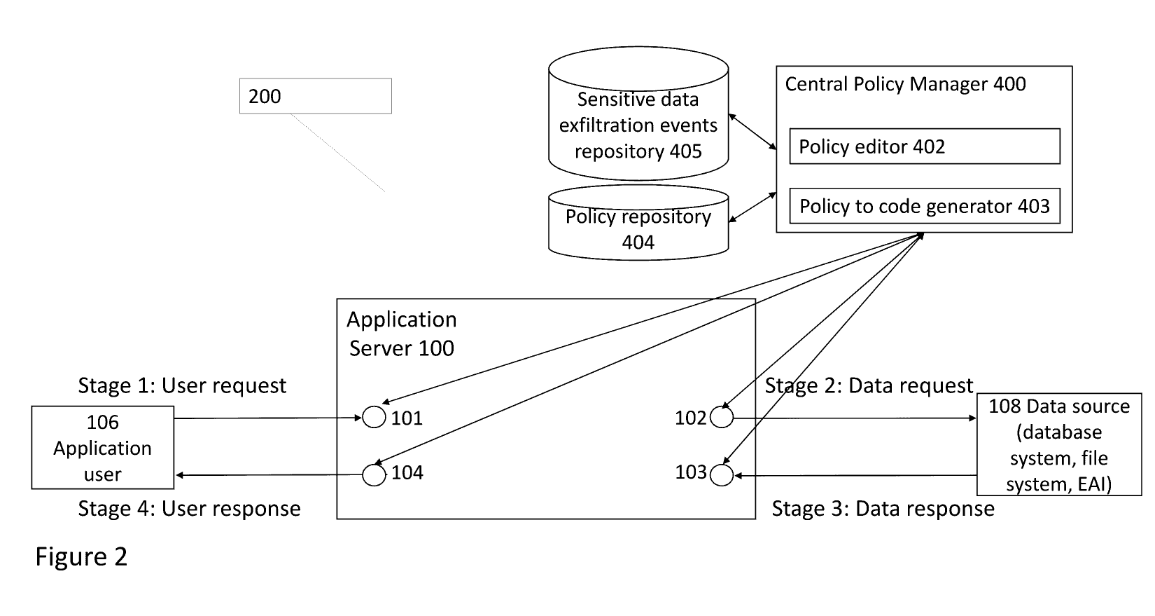

FIG. 2 shows an exemplary, illustrative non-limiting system for constructing and injecting injectable code to provide real-time monitoring capabilities. System 200 features a central policy manager 400, a policy editor 402, policy to code generator 403, and connections to a sensitive data ex-filtration events repository 405, and a policy repository 404. In this figure system 200 is expanded to show what occurs after detection in the case where code is to be actually injected into the real-time applications. As previously described with regard to FIGS. 1A and 1C, detection may optionally occur within application agent and/or with one or more network sensors that are present between application user 100 and the data source 108. However, in this case, preferably central policy manager 400 features a policy editor 402.

Policy editor 402 can receive some information about sensitive data flow samples, sensitive data source objects, application user names, roles and responsibilities, organization structure, patterns that match sensitive data and privacy regulations and then creates and edits the policies. Another option, is to import into the policy editor a predefined set of policies that have been purposely built for the application, organization or use case at hand (for example, list of policies for detecting sensitive client information exposure in a Customer Relationship Application (CRM) application).

These policies can then be stored in the policy repository 404. In addition, cases in which sensitive data has been detected may then optionally stored in sensitive data ex-filtration events repository 405. After policy editor 402 has been used to create the policy then policy decode generator 403 preferably generates injectable code for detecting sensitive data flows or sensitive data transactions (adding, changing or deleting data, referred to as “monitoring”) and optionally enforcing, transactions according to the policy. Optionally, such injectable code is not used, but if present, injectable code is preferably inserted into each of the run-time application programs 101, 102, 103, and 104, thereby allowing each stage of the information flow between the application user (for application 106) and the data source 108 to be accurately monitored. Activity through application server 100 itself can also be monitored for the presence of sensitive data and/or of the presence of a request for such data, preferably even before the sensitive data itself becomes present (for example, detecting sensitive information request in the user request stage, identifying that a specific URI and a set of parameters causes sensitive application data to be exposed from the data source to the requestor 101). Such injectable code is optionally and preferably used for greater real-time responsiveness to sensitive data requests and to the presence of sensitive data.

The Central Policy Manager (400 in FIG. 2) defines and edits policies. The Policy to Code generator (403 in FIG. 2) generates the run-time code and injects it into the appropriate stage's run-time programs within one or more applications.

The injection can be initiated by the central server (400 in FIG. 2) and/or by one or several of the instrumented run-time programs (FIG. 2 101, 102, 103, 104).

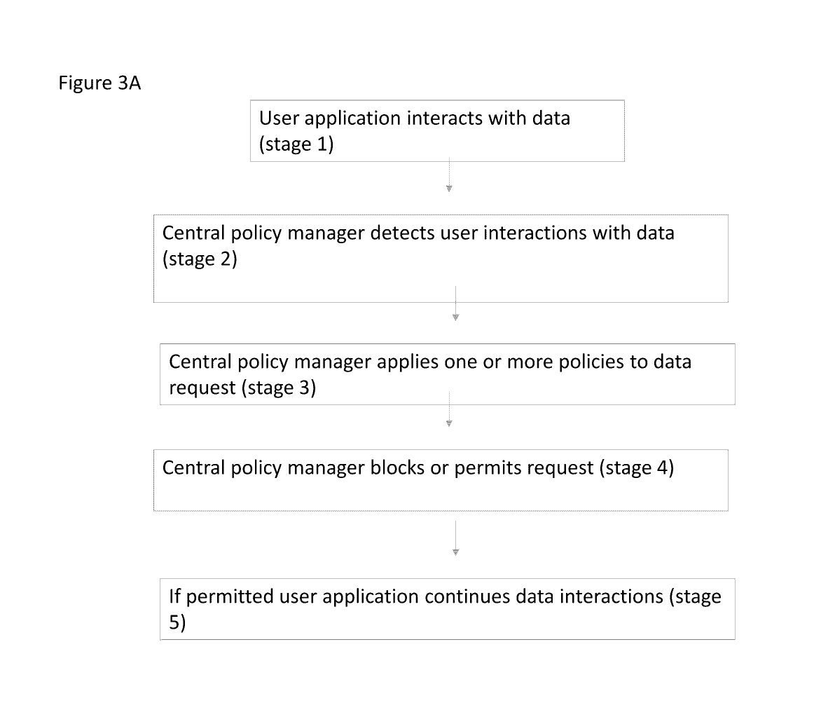

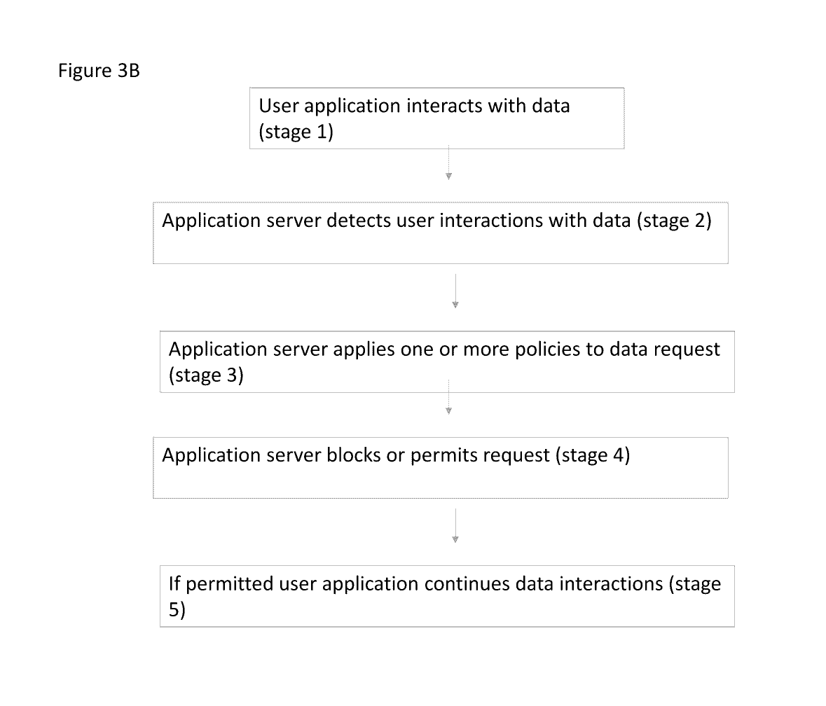

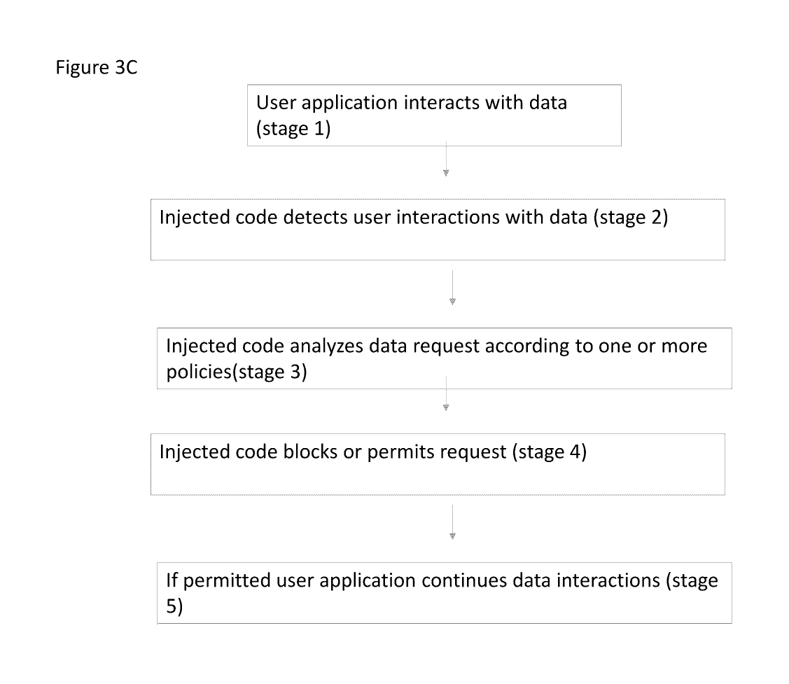

FIG. 3 shows an optional distributed configuration. In the distributed configuration option, no central server is needed as one or several of the run-time programs operate as a central server. This option also applies to the case when the configuration is stored in a database or in a file, and is accessed by the runtime programs.

FIG. 3A shows an exemplary, non-limiting illustrative flow in which the central policy manager defines policies in one or more of the request data flow stages, that when translated into code and injected into the application server, detect user interactions with the data. Optionally such flows may including performing one or more actions to determine whether such interactions include exposure of sensitive information, and can apply actions, such as auditing the request, results and any other relevant context into the Sensitive data exfiltration events repository 405, blocking the request, alerting or notifying appropriate administrators, or redacting/anonymizing/masking/encrypting/decrypting/tokenizing/de-tokenizing some or all of the data that otherwise would have returned to the user (collectively referred to as “blocking” in following texts).

In stage one the user application interacts with the data, for example, running a request to receive sensitive VIP client data. In stage two, central policy manager detects the sensitive data output that the user has performed by detecting one or more requests or other interactions of the user application with the data. In stage 3 the central policy manager applies one or more policies to the data request; as previously described such policies need to be created in advance according to the presence of sensitive data. In stage 4, the central manager policy audits the request, results and any other relevant context into the sensitive data exfiltration events repository 405 (the term “audit” relates to this activity), and optionally blocks/redacts/anonymizes/masks/encrypts/decrypts/tokenizes/de-tokenizes some or all of the data of the request according to the policy. In order for this to occur, of course, central policy manager must be able to detect all user interactions with the data through the user application or at least all relevant user interactions. In stage 5, the permitted the user application continues the data interactions. If, however, they are blocked then further data interactions do not occur including, for example, the delivery of sensitive data.

FIG. 3B shows a similar flow except that the application server itself performs the detection and determining whether or not to audit, permit or block the interactions. Again, in stage one, user application interacts with the data, but now in stage 2 the application server detects such user interactions with the data. Again, by detecting the request or other interaction of user interaction with the data. In stage 3, the application server applies one or more policies to the data request as previously described with the regard to FIG. 3A, except that now the application server applies such policies rather than the central policy manager. In stage 4 the application server audits, blocks/redacts/anonymizes/masks/encrypts/decrypts/tokenizes/de-tokenizes some or all of the data of the request, and if permitted, as previously described with regard to FIG. 3A, in stage 5 the user application continues with the data interactions. If the interactions are not permitted then they are blocked and no further interactions may occur.

FIG. 3C is another exemplary flow with regard to detection of user application interactions and either permitting or blocking such interactions. Stage 1 is as for FIGS. 3A and 3B. Now, however, in stage 2 one or several injected code applied in one or more stages detects user interactions with the data based on the policies that have been defined in the policy editor, transformed into run-time code and sent to the agent, for instrumenting in one or more stages. The injected code is preferably present as previously described in the actual run time code of the user application and/or of the data resource and/or of an application or code being run on the application server. The injected code is able to detect user interactions with the data in real time that is as part of the normal application program code operation which would in any case occur due to the user application interactions with the data. In stage 3 the injected code analyzes the data request according to one or more policies. Again, the policies need to be previously set changed into run-time code and added to the injected code, which now is appended to the application stage processing logic to make the determination in real-time in run-time as part of the regular flow of the user application interactions. In stage 4 the injected code determines whether to block/redact/anonymize/mask/encrypt/decrypt/tokenize/de-tokenize some or all of the data of the request. If the request is permitted then the user application continues the data interactions to stage 5 otherwise no further data interactions are permitted and the process stops as previously described.

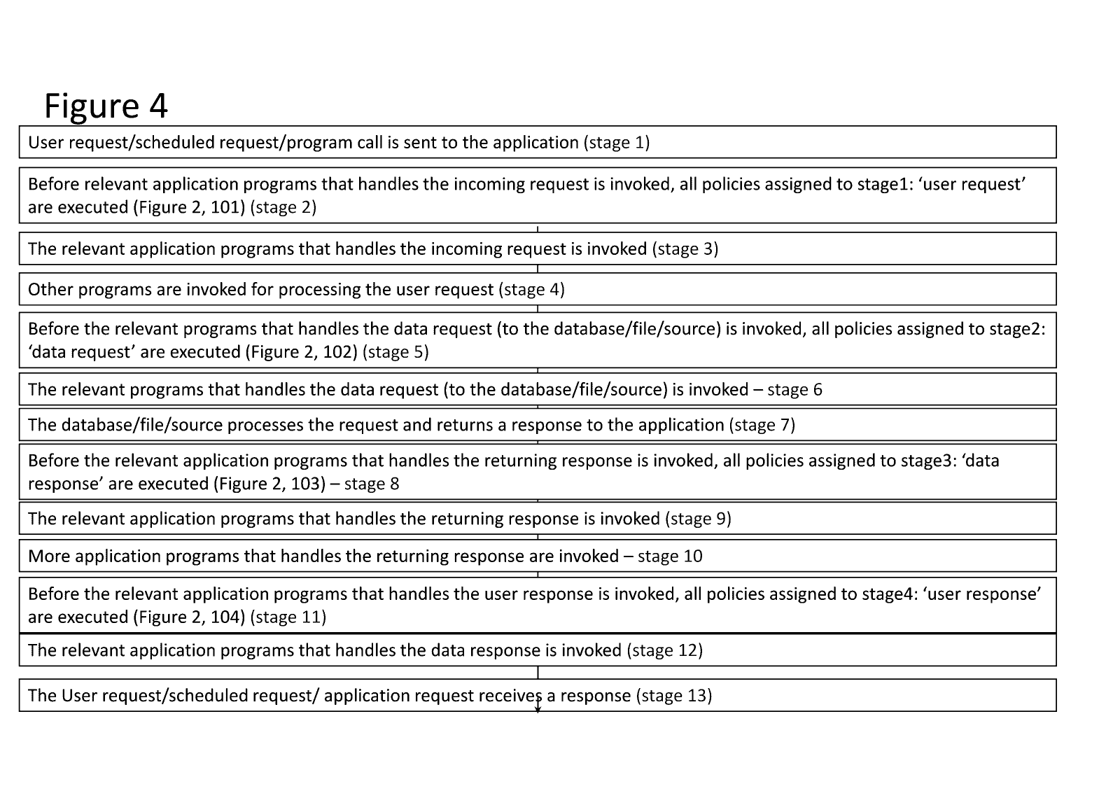

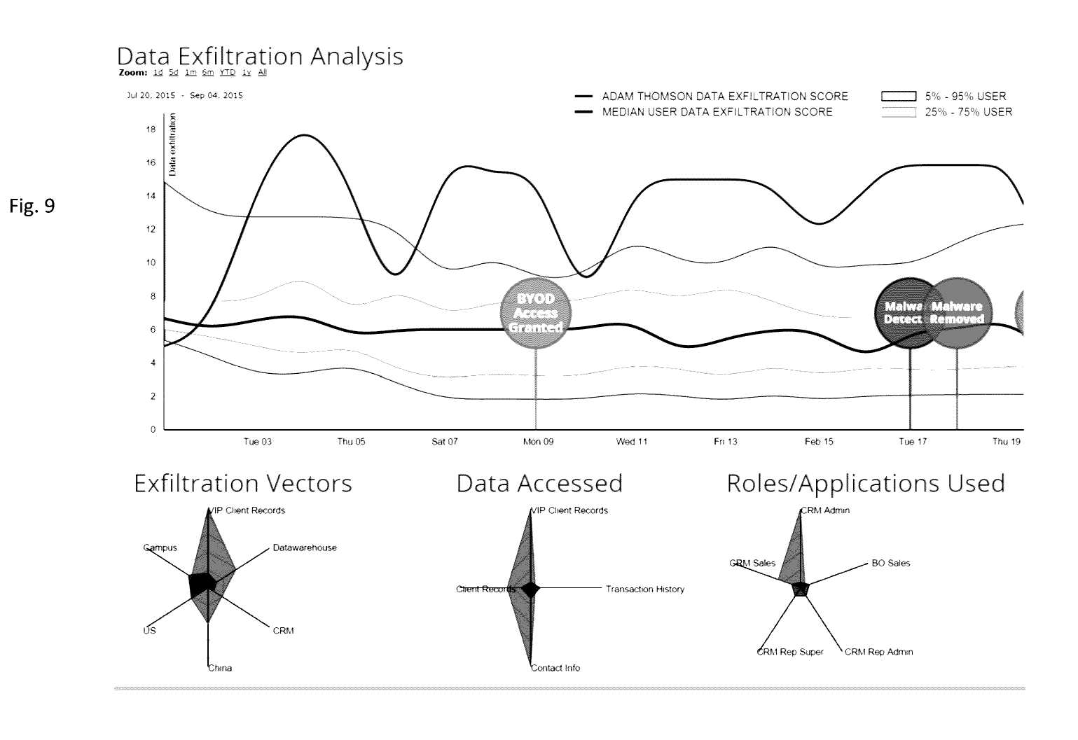

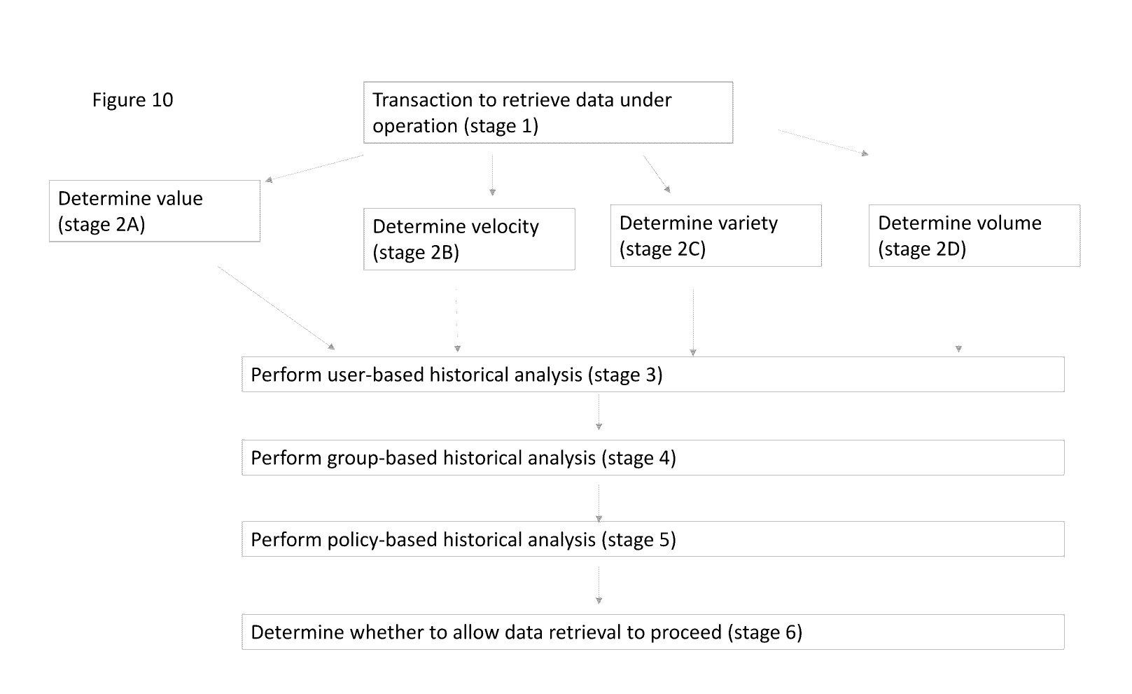

FIG. 4 is an exemplary, illustrative, non-limiting flow which shows the details of the flow of FIG. 3C in greater detail. In stage 1 the user request, user application requests, scheduled requests, or program call is sent to the application. The application in this case may optionally be the user application, an application run on the application's server and/or a data source application. In stage 2 before the relevant application program that handles the incoming requests is invoked, the previously described policies are instead applied to, and executed on, the user request, schedule request, and/or program call. Next, the relevant application programs that handle the incoming requests are invoked. In stage 4, optionally other programs may be invoked for processing the user request. In stage 5, however, before the data request is handled by the relevant programs, for example at the database or data-file source or before other data resource may be invoked, all policies assigned to the data requests are preferably executed. As previously described such policies may optionally only be applied to a subset of requests (to minimize performance overhead) to one or more combination of variables, such as the user application, only be applied to the application server, or only be applied to the data source, request type, data source objects, size of result set or the 4V score of the request. The term “4V score” relates to a particular scoring system which includes data sensitivity and other aspects of the request, which uses various variables and values to compare to one or more policies, as described in greater detail below with regard to FIGS. 9 and 10.

Next, in stage 6, the relevant programs that handle the data request, now in this case to the database and/or to the file and/or to the data source are invoked. In stage 7 the database and/or file and/or data source processes the requests and returns a response to the invoking application. In stage 8, however, before the relevant applications that handle the returning response may be invoked one or more and preferably all policies assigned to this particular stage are executed. This is the stage of the data response and so optionally policies may only be applied to this stage and/or specific policies may only be applied to this stage. These policies can block/redact/anonymize/mask/encrypt/decrypt/tokenize/de-tokenize some or all of the data of the response. In stage 9 the relevant applications programs that handle the returning response are invoked. In stage 10, more application programs may be invoked that are necessary to handle this response. Again, before the relevant applications that can handle these responses may be invoked, policies assigned to the user response stage are preferably executed in stage 11. These programs can block/redact/anonymize/mask/encrypt/decrypt/tokenize/de-tokenize some or all of the data of the response. In stage 12 relevant application programs are invoked to complete this stage and in stage 13 the user request, scheduled request, and/or application requests receives a response.

Optionally at any and all stages where a policy is invoked the entire process may be stopped or at least the process of permitting data and/or a particular request or response to be transmitted may optionally be stopped.

The central policy manager also can collect, analyze, modify, replace or delete all request context and variables such as system information (environment,), user information, application information, request information (e.g. user computer IP address, requested URL, request headers, cookies, end user mobile device fingerprint etc), and data information (e.g. all parsed SQL requests and result set structure, titles and values, outbound output http requests and responses, etc). For example, the central policy manager can replace a certain result set value retuned from the data source into ‘xxx’ applying dynamic data masking. Same result can be done by having the central policy manager replace the user response HTML, JSON or XML context retuned to the end-user, or by rewriting the data source request—SQL request sent to the database.

Similarly, encryption or tokenization can be performed on all injected stages—encrypting/decrypting/tokenizing or de-tokenizing values in several or all of the instrumented stages—such as replacing the URI request parameters, and/or rewriting the data request command, and/or replacing the returned value or replacing the returned output values.

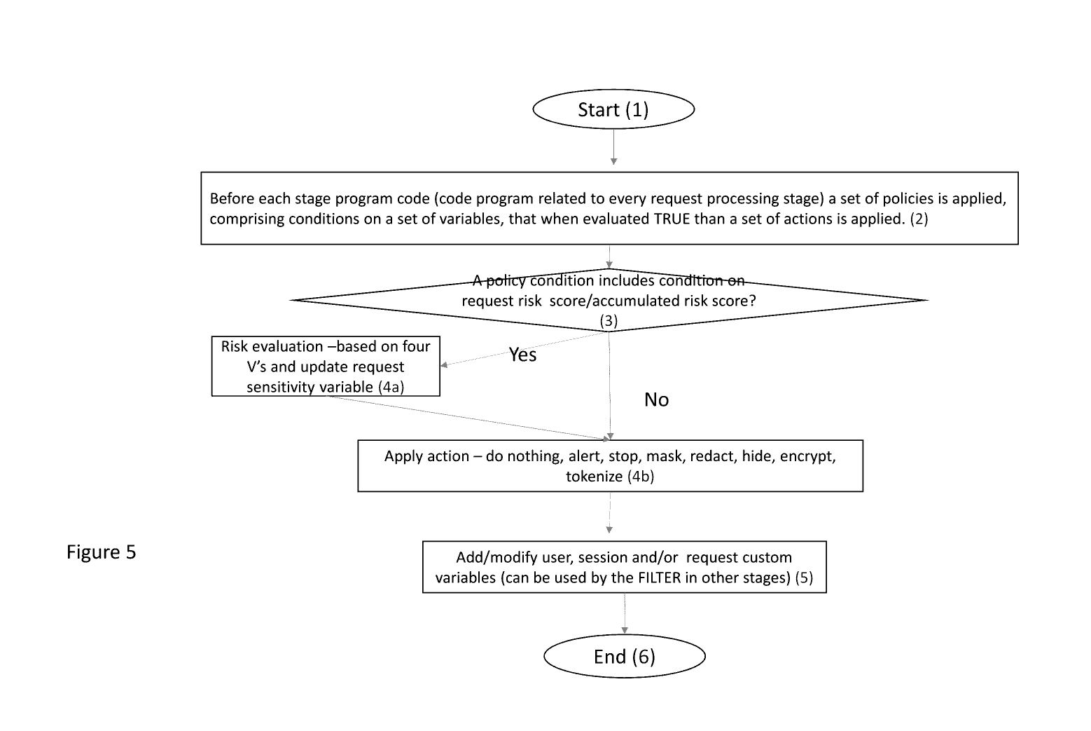

FIG. 5 shows the flow of each run time program (injectable code) that is attached to, or injected within, one of the application programs on the application server in the run time environment. These real-time programs were shown in FIGS. 1A, 1C, and in FIG. 2, as run-time programs 101 to 104. This flow in FIG. 5 optionally and preferably relates to the flow of the injected code which is added to the run-time program. The process starts at stage 1, next in stage 2 before each stage program code, that is the code that is related to the processing stage of each request, may be invoked optionally and preferably one or more policies is applied. Comprising conditions on a set of variable that if evaluated true cause a set of actions to be applied, such as for example, auditing, permitting blocking/redacting/anonymizing/masking/encrypting/decrypting/tokenizing/de-tokenizing some a particular request or transmission of data. In stage 3 the policy, if the policy condition includes an accumulative risk score or a sensitivity score (or other type of scoring), and that score has been triggered, then in stage 4A a risk evaluation is performed based on the 4V model (described in greater detail with regard to FIGS. 9 and 10), and an updated request for sensitivity variable is noted. If not, then in stage 4B an action is applied which may do nothing, audit, alert, stop, mask, redact, hide, encrypt, decrypt, tokenize or de-tokenize. Also after stage 4A the process preferably continues automatically to stage 4B.

Stages 4A and 4B are preferably performed in order to determine whether cumulative risk has occurred. For example, optionally, a user may be either permitted or even required in the course of his or her daily work to check data on a certain number of VIP clients, even up to 1000 VIP clients if that is required for the employee's work. However, if the employee were to instead to request data on a far greater number of VIP clients—5000 or 10,000 this may optionally tagged as suspicious. For other employees, requesting on data on more than 10 VIP clients of the system may optionally be considered to be suspicious. Therefore, the sensitivity variable preferably determines the sensitivity of the type of data being requested and also the role of the employee making that request to determine whether this is a usual request or whether, perhaps, this request should be flagged as potentially problematic. In stage 5, the employee may be added or modified, and/or a session or other custom variables may optionally be invoked, which could be used by the filter in other stages. This for example may optionally occur if an admin or other employee is required to update the process on the fly.

Detailed Example of an Encryption/Tokenization Policy:

A policy for data encryption is defined, containing the following information (for a data source of type relational database)
1. Name of the column (and additional metadata to identify the column such as table, schema, catalog, database identification)
2. Policy type—Encryption/tokenization
3. Type of encryption/tokenization to apply including format, if using format preserving encryption, or specifying the API to an encryption/tokenization service.
4. Additional conditions that will be evaluated by the run-time program before the encryption/decryption occurs. For example, decrypting or revealing certain special or VIP customer names only to users with a certain IP address, geolocation, position etc. Only these users will see decrypted VIP customer names while other unauthorized users will see encrypted VIP customer names.
For example:

Given a policy to act on CreditCardTable.CreditCard and secure it at rest:

Injected code apply that policy on every INSERT/UPDATE (throughout the system), and apply the policy for READ access only for authorized user ADAM:
1. Select CreditCard, Email from CreditCardTable
a. For user ADAM Decrypt result set, leave the result encrypted for all the others.
   2. Insert into CreditCardTable values(‘5865-3443-2323’, ‘myBrokenEmail@yahoo.com’)
a. For all users injected program will trigger an encryption on ‘5865-3443-2323’ which will rewrite the query before it is executed
   3. Insert into CreditCardTable values(?, ?)
a. When executed with the values ‘5865-3443-2323’ and ‘myBrokenEmail@yahoo.com’, the value of the credit card will be sent encrypted to in the binding statement.
   An alternative implementation is to use an encryption/tokenization stored procedures and re-write the queries to use the data source stored procedures that will perform the encryption/decryption. This will be done in the application server “data request” injected run-time program to manipulate the statement before it is sent to the database server, and based on the current CONTEXT in the request (much the same way as before)
   for example
   1. Select CreditCard, Email from CreditCardTable
b. Would be re-written into: Select Decrypt(CreditCard), Email from CreditCardTable
   4. And the insert
a. Insert into CreditCardTable values(‘5865-3443-2323’, ‘myBrokenEmail@yahoo.com’)
b. Into: Insert into CreditCardTable values(encrypt(‘5865-3443-2323’), ‘myBrokenEmail@yahoo.com’)
   5. Also Insert into CreditCardTable values(?, ?)
   6. Will be rewritten into Insert into CreditCardTable values(encrypt(?), ?)

### Encrypting/Tokenizing API Application Requests

The injected run-tome program identifies API calls or data source calls using URL and xpath/Jsp.path that contain elements that needs to be encrypted/decrypted+format/Keyset to use for automatic encryption. The Injected run-time program replaces the original values with encrypted/tokenized values or with decrypted/de-tokenized values.

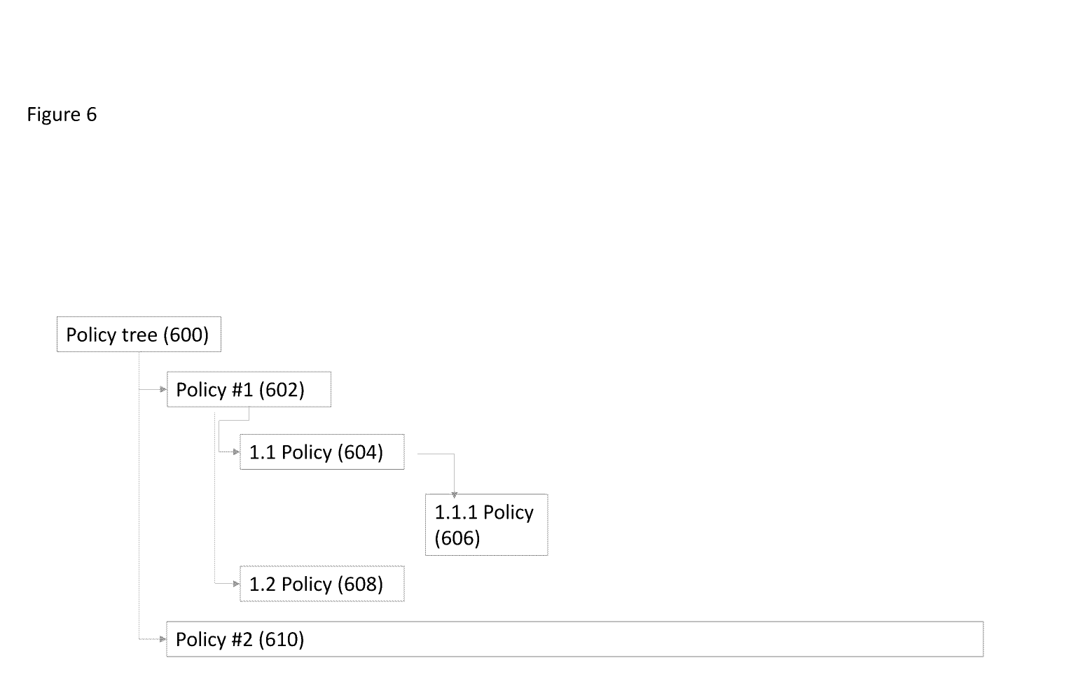

FIG. 6 shows an illustrative, non-limiting example of a policy tree, shown as a policy tree 600. Each policy is preferably built from a list of conditions. These list of conditions may optionally be structured and invoked in the form of a tree. For example, some conditions may require more than one variable condition to be true to continue where other may require such conditions to be false to continue. If all conditions in a policy are evaluated to be true than optionally and preferably an action is applied such an audit, an alert, a block, encrypt, tokenize etc. The policy preferably includes an attribute to set further policy processing, continue policy processing, by-pass the next policy to get into the stage and/or to bypass all their policies in all stages for example. Each policy may also optionally include an ability to define a variable with a value or populated with a result of a program. This variable can be used by other policies in the policy trees within the specific user request, entire user session (that includes multiple sessions), or in some or all sessions of all users (referred to the setting of a global variable). Policies are optionally and preferably structured as a tree of policies such that each policy is preferably evaluated from the top down.

Child policies are preferably visited only after the parent policy is evaluated to be true. If a policy is evaluated to be false the evaluation may optionally continue to the next parent of that, in that level, rather than to continue to a child policy. So for example, in this policy tree as shown, policy 1 (602) is evaluated, optionally the process continues to evaluate policies 1.1 (604) and then 1.2 (606) only if the condition of policy 1 (602) is valid. Similarly with regard to policy 1.1 (604) the process continues to evaluate the sub-policy of 1.1.1 (608) only if the policy condition of 1.1 (604) is valid and so forth. With regard to policy 2 (610) however, which is not a sub-policy to policy 1 (602), this policy is optionally visited and processed. If policy processing was set to continue in all previous policies and/or if the previous policies conditions were evaluated false. This structure is made so that the policy processing does not continue under conditions where it is clearly not correct and on the other hand also permits hierarchical processing of policies according to the admin or other users preferred structure.

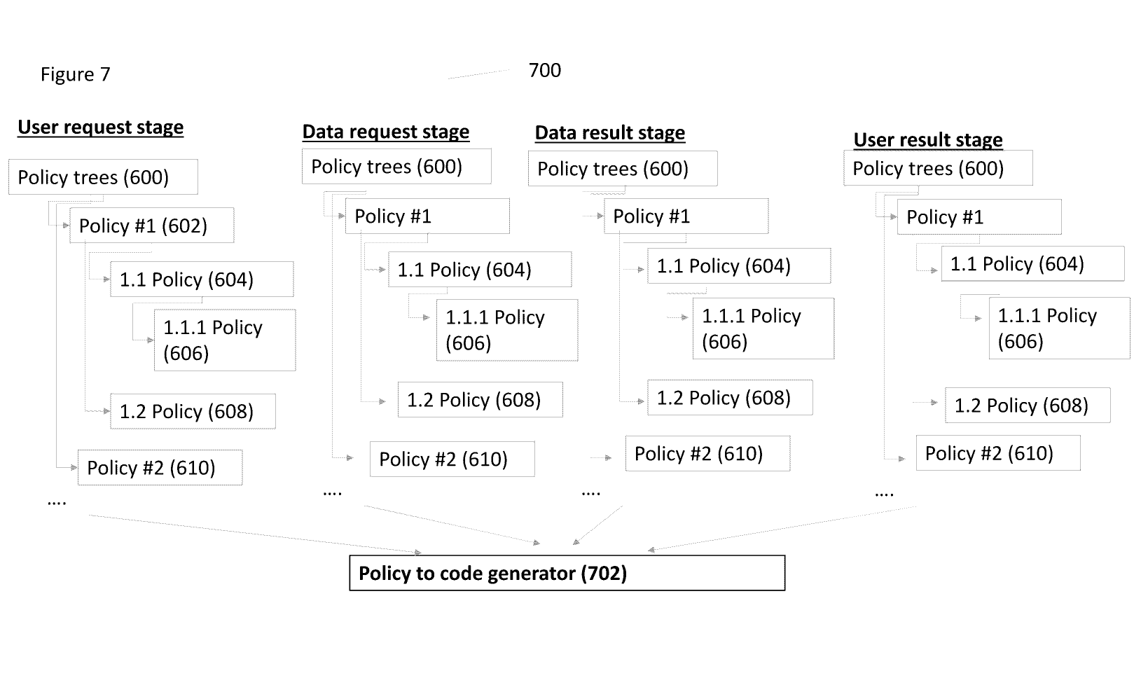

FIG. 7 shows a non-limiting example of how various stages may lead to policy trees being generated which in turn may optionally be used to create a policy code generator. In FIG. 7 there is a system 700. System 700 optionally and preferably includes a user request stage, a data request stage, a data results stage, and a use results stage. Each such stage has a policy tree 600—meaning a set of policies applied on each stage in the form of a tree as previously described (numbering follows FIG. 6). The policy trees 600 are optionally and preferably created, and then used to inform policy to code generator (702) so that code programs can be generated from the set of policies to be executed before the appropriate stage program code. So then for example, policy to code generator 702 may optionally generate code for the user request stage which would occur just before the program code which is performed in the stage.

The application admin can optionally define multiple trees 600 of conditions and actions to be injected to application run-time programs for performing each stage. For example, for the stage data result, optionally and preferably, the code can be injected immediately before the JDBC driver receives the request. The general run-time code is then injected into each of the application codes at each stage to be certain that the policies are correctly applied at run-time.

FIG. 8A shows a non-limiting example of a system featuring a run-time environment. A system 800 shows an example of an application run-time environment 802 with again the user request stage, the data request stage, data results stage, and user results stage. Each such stage features a stage program code (812) which is then injected into real-time programs (804) to instruct the programs with regards to one or more actions (810) such as bypass all or partial policies in the stage—or bypass all stages (primarily to improve performance related to non-sensitive data requests), audit, alert, encrypt, decrypt, tokenize, detokenize or block, and which in turn are revoked according to filters and conditions (808). All of this code is preferably created by the policy decode generator 403 as previously described which is shown again in the central management server and in the policy manager 400. The central management server is therefore able to define policies, transform them into run-time program code, and propagate these policies to the different stages within the application run-time environments across multiple application servers. Policy manager 400 communicates with application run-time environment 802 through a network 806.

FIG. 8B shows the application run-time environment of FIG. 8A as previously described in more detail, in communication with the central management server (820). Central management server (820) in this case also features a batch concept module (822) and batch operation (824) for the analyzer. Every variable and risk evaluation and the 4V model risk score and cumulative risk score calculation can be performed in real-time, and/or in batch mode (to reduce the overhead and time wait of the online request that awaits the response of the calculation within the policy tree processing). What processing will be done in real-time on the application server, and which processing will be performed on a batch model is determined either by the administrator, by setting performance thresholds, based on previous processing statistics, based on server utilization, time of day, processing time or any other available variable or a combination of these.

Central management server (820) or real-time server (814) preferably receives information from third party sources (844) such as LDAP databases and human resources applications. The reason for this is that some variables are created within each user request and some variables are created only periodically, such as every hour, day, week and so forth (thus the LDAP request which takes time and resources is optionally and preferably not executed PER user request that can generate high-load on the LDAP server, BUT performed once every hour/day/week or per session), where the results would be populated in a variable for concurrent use by the various run-time program policies. When a certain variable within a condition requires “batch” calculation and thus cannot be validated in real-time the variable would use a previous or predefined value which enables real-time in-stream evaluation as not to cause any delays to the stage processing. The batch variables can include an integration with third-party identity management systems or with LDAP services, to extract user role in organization assignments which optionally and preferably can be done once a day.

In other situations, the central management server may optionally need to check each variable and compare all of the information that the users are exposed to. This could take time and may not be done in real-time but offline. For example, in order to calculate the sensitivity score of a result set, the respective instrumented run-time program code or the relevant stage would send the result set to the batch 4V request score analyzer. The batch process analysis would calculate the would be returned as a variable value that will be than returned back to the run-time program code (the real-time server 814) as an accumulative risk related variable for previous or following user request stages or for previous or following user requests that meet certain variable conditions. Real-time server 814 preferably operates a real-time context determination module 816, for determining context for real time requests; and a real-time request score analyzer 818, for determining the score for requests, to determine whether they are acceptable (optionally the 4V score is used as described with regard to FIGS. 9 and 10).

Another option, is to have define in the agent operating at the application server a Bloom filter data structure containing for example 10 million black listed IP addresses. The set defined in the Bloom filter can be populated whether by the agent itself (e.g., by having the agent connect to a service that returns a list of black listed IPs), or created by the central policy engine.

The agent can then use the Bloom filter in real time to test whether an element is a member of a set. In this example, if the IP of the device login into the application is found in the black listed IP addresses, then the element “IP address” is a member of the blacklisted set.

FIG. 8C, again, shows the application run-time environment with the central management server and, which in this case, also includes an optional data logger 826. The data logged by the agent is sent to sensitive data ex-filtration events repository 405 which was already shown in FIG. 2. The system preferably collects ex-filtrated data as a result set and the request context is sent into sensitive data exfiltration repository 405 which may then be optionally used for the sensitivity model, and in particular for the batch context and batch 4V request score analyzer.

FIG. 9 shows a non-limiting exemplary display of the results of the data exfiltration analysis. This screen presents a type of analysis produced by the system in which the user exfiltration is scored based on each individual transaction, and optionally compared to his/her peers. If each transaction is scored individually and then the scores are added up, they would preferably add up to a 100 accumulated on a timed basis. This is preferably analyzed the logarithm scale in order to normalize and easily identify the spikes. The user is then compared to his or her peers, so for example, a user would be compared to his or her peers in the same department, and in addition any alarms would have to be set up if some user deviates significantly from the average or median user and particularly from the 95th percentile user in his or her department. The data is preferably graphically presented with regard to ex-filtration vectors, data access, and roles, and/or applications used. FIG. 3A shows a more detailed optional exemplary method for assisting a user to determine which data is sensitive if an application agent is being run.

The application agent contains a deterministic lineage between the user request, user response, data source request, and data source response. This is because the application agent records all of the functionality, request and response, from both the user application and also from the data source and, of course, from the application server itself.

This deterministic session tracking id, collected by the application agent, enables the lineage to be determined whether performed in a production environment or a non production environment and with any number of users.

The system then collects the application session tracing id for each user request, data request, data response, and user response. By collecting this series of session tracking ids, the system is able to compare the session tracking ids across the run-time programs that process the request, and the network events as they are recorded by the sensors 400 and 401 in FIG. 1C. All events with the same session tracking id represent a single user's request interactions—thus lineage containing these events, and the connection between the events, is accurately identified, preferably across ONLY the four sensitive data flow stages (as presented in FIG. 1A 101, 102, 103, 104). The focus on only four stages is preferred in order to optimize between the need to collect sensitive data flows on one hand, and the need to reduce performance overhead, latency and complexity (due to the run-time program code that is executed in line to each one of the stage run-time programs).

Next, the system can collect certain request variables within one or more stages (the user request, the data source request, data source response, and the user response), in order to identify the sensitivity score (4V model) of the request, the data source objects (e.g., tables and columns when the data source is a relational database) of each sensitive data value (e.g., Social Security number value that has been identified as sensitive by an end-user is found also in the first column within the result set response). Parsing the SQL request enables the system to detect the table and column that populate the first column of the result set—hence identifying the source of the social security number value.

FIG. 10 shows a non-limiting, exemplary method for determining the “4V” model score. As shown in stage 1, the process starts when a transaction to retrieve data is under operation by a sensitivity request classification and scoring analyzer: automatically classifying each request.

The sensitivity score of each user request is calculated based on the “four V model”, comprising of Value, Volume, Velocity and Variety:

Value (stage 2A): the sensitivity level of the data exposed to the user. The sensitivity is calculated based on administrator providing “sensitivity score” on each data source object. For example, in database, the sensitivity score is optionally and preferably based on schema name, table/view name, column names and sensitivity score. For example, client name column in the client table. For example, table customer, column customer_name sensitivity score is 10.

Volume of the sensitive data (stage 2D). The volume is the number of sensitive records returned to the user.

Variety of the data exposed (stage 2C). Variety means the number of unique records exposed within a certain time window (e.g., variety within 5 working days) Velocity of the exposure events (stage 2B). Velocity adds a factor to the sensitivity score of a user based on different anomaly behavior indicators, such as abnormal behavior of data exfiltration, accelerated exfiltration behavior per time frame, exfiltration red-lines crossed and peer comparison.

Details:

Calculating Request Sensitivity Score

Calculating sensitivity score of user request is based on the “four V model”, comprising of Value, Volume, Velocity and Variety.

Value score calculation may optionally be performed as follows.

### 1. Prerequisites:

An administrator defines a list of objects, including URI, requests, SQL requests, data objects such as tables, views and columns, stored procedures or program code, or API calls. For each entry in the list, the administrator assigns a sensitivity score. All values support regular expression or wildcard entry. For example:

| Schema | Object name | Result set values | Sensitivity | Classification |
|---|---|---|---|---|
| Apps | Table Customer, | Select customer_name from | 2 | PII |
| | column | customer where VIP = ‘No’ | | |
| | customer_name | | | |
| Apps | Table Customer, | Select customer name_name from | 8 | PII, VIP |
| | column | customer where VIP = ‘Yes’ | | |
| | customer _name | | | |
| [.*] | Table Employees, | No filter | 5 | PII |
| | column name | | | |
| URI | URI | app.newco.com\cashwithdrawal | 20 | Sensitive |

Each request that is not filtered out, is parsed and matched with the list objects, automatically assigning them sensitivity score and the classification. Classifications are used for both grouping and analyzing sensitive requests as well as adding another multiplier factor to the sensitivity score.

Another optional source of sensitivity objects is a predefined policy tree which already has been built for a certain packaged business application (such as SAP ERP application). The packaged application uses a fixed data source objects for their sensitive data and the system can discover this structure (from a discovery process, application source documentation, prior experience) and import it into the “4V” model.

Classification examples include PCI related requests, VIP data related requests.

For example:

| Classification | Multiplier |
|---|---|
| PII | 2 |
| VIP | 4 |
| Sensitive | 1 |

When a user submits a request: “select customer_name from customer” and the response includes VIP customer names, the sensitivity score is 8×4 (8 is the object sensitivity score and 4 is the sensitivity multiplier assigned to the classification ‘VIP’), totaling 32 sensitivity score for the request. In case several classifications are assigned to the request, the highest multiplier is used for the sensitivity score calculation, but other options, such as factoring both classifications is optional.

Volume Calculation:

The request volume is based on the number of data returned to the user. For example, the system calculates the value of the request “select customer_name from customer” to be 32. As the request retuned 10,000 VIP client records, the total sensitivity score is 32×10,000=320,000.

The sensitivity score can be presented in logarithmic scale, thus the sensitivity score is 5.5

Variety Calculation:

Variety is defined as an end-user exposure to new sensitive information records that were not exposed to a user in the past. For example, a sales representative that is continuously exposed to the same customers that he/she works with (as should be) will have low variety score, until the sales representative explores new customer information that was not exposed to him/her during the predefined time period (for example, last week, last month or ever). In some cases, before the sales representative resigns and moves to a competitor, he/she might decide to expose him/herself to more customer information than necessary to perform the current role.

In at least some embodiments, the invention calculates variety based on the uniqueness of the result set during a certain time period (defined as a parameter value).

For each request, the sensitive records from the result set are compared with previous sensitive records that were exposed to the user during the last X days. Sensitive records that already have been exposed in a previous user requests are removed from the volume score, and thus reduce the sensitivity score of the transaction to equal only unique sensitive records.

Example: the parameter “Variety number of days” is set for 3 business days. The sales representative ran a transaction two days ago exposing 100 VIP clients. The sales representative ran the same transaction now, retrieving the same 100 VIP clients—thus the sensitive score of the newly request is 0 (as 3 business days did not pass from the previous exposure). If the sales representative will run the request one week later, exposing the same 100 VIP clients, than the new request will have again a sensitivity risk score of 32×100-3,200. In order to reduce false positive alerts in the system, the amount of business days can be extended to 30 days, thus only activating a high risk alert when the representative is exposed to a large number of new customers that most probably where not required for her to perform her job.

The VARIETY is also preferably used to answer the following—how has the user accessed the sensitive information of client X, when and where (using which application, client information). This is the essence of all privacy regulation—that impose a concept of “need to know” basis, namely if an application user is accessing personal information on a client without a real business need, that this is unlawful.

Variety Calculation Based on the User's Exposed Data Sets and Actual Sensitive Values:

A user accesses information from one hundred clients, including client names, addresses, Social Security numbers and account balances. In the following example, customer name is used to explain how VARIETY is measured, which is the case with any other sensitive value.

Each sensitive value exposure occurrence is captured by the System, including but not limited to the value, a unique identifier of the sensitive entity (for example, for each customer name value, the customer_ID information is also collected. For employee SSN (social security number) value, the employee number is collected). This is done to uniquely identify the sensitive data exposed including the session tracking id and a time stamp. This minimal context is preferably collected for each sensitive data element that is exposed to every user.

For example, if both customer name and customer SSN is exposed to an application user (by detecting an end-user access the “order entry” application screen), then two VARIETY records are added:

| Object | | Identifier | Session | Application | | |
|---|---|---|---|---|---|---|
| name | Value | Customer_id | tracking id | name | Time stamp | . . . |
| Customer | John Tiger | 132435465 | 987654321 | CRM | 10-Oct-15 | |
| name | | | | | 04:04:04 | |
| | | | | | 11:21:12 | |
| Customer | 9999- | 132435465 | 987654321 | CRM | 10-Oct-15 | |
| SSN | 999999 | | | | 04:04:04 | |
| | | | | | 11:21:12 | |

Note:
in some cases, the “Value” and\or “Identifier Customer_id” values can be hashed, masked (XXX), tokenized or encrypted - in order to keep the confidentiality of the sensitive data.

Different options are presented to collect the variety of sensitive data:
1. Based on parsing the SQL/data source request and collecting the resulting data structures:
The policies include a description of the sensitive data source objects as well as a unique identifier for each value. For example, the policies include a policy on the customer header table, the customer name column and the customer_id column.

Whenever a user runs a SQL “select” request with a result set that includes customer_id and customer name—both these values are collected by the system.
2. Another option for a “Variety calculation” policy is to use the structured result set: The result set of the sensitive requests include a formatted column names and result data. A policy can be created to collect the customer name data based on the column name, in addition to the customer_id column or any other distinctive means that enables to identify the specific customer (e.g., a unique key value). If customer_id or any other unique key is not included, then the customer name itself will be used to identify uniqueness of the record.
3. Another option is to use the request output:
The output of the sensitive requests include an object with A policy can be created to collect the customer name data based on the column name, in addition to the customer_id column or any other distinctive means that enables to identify the specific customer (e.g., a unique key value). If customer_id or any other unique key is not included, than the customer name is optionally used to identify uniqueness of the record.

The system encrypts or tokenizes or applies a hash function on these values either or both in the real-time request score analyzer and on the batch 4V request score analyzer

The System collects all sensitive information that the user accessed.

The Variety calculation can be performed in real-time, by the Real-time request score analyzer and by the Batch 4V request score analyzer or based on a combination of the two.

Deciding where the VARIETY calculation will be performed (in real-time or batch) can be determined by the system administration, based on the request variables (such as system, user, session, request, classification and object variables or combination of those).

Velocity Calculation:

Velocity is defined as a multiplying factor (between 0-100) for calculating the sensitivity score of the transaction. For example, if the Velocity factor is 2, and the sensitivity score of a request is 3,200, than the updated sensitivity score is 3,200×2=6,400. The log(6,400)=3.8.

The factor is calculated based on the following use cases:

Abnormal behavior of data exfiltration: Exfiltration that occurs in a deterministic way. For example, exfiltration every X seconds over a certain period of time can only be performed using a malware. When this behavior is identified, a high factor value is assigned to the requests.

Accelerated exfiltration behavior per time frame: when either the amount of sensitive records exposed, and/or the sensitivity level of the request, and/or the number of sensitive requests during a time interval has substantially increased by more than an X times compared to the previous time interval a high factor value is assigned to the requests.

Exfiltration red-lines crossed: When a predefined threshold of the sensitive data volume exposure has been crossed: for example, VIP customer exposure threshold is 1,000. Every user that is exposed to more than 1,000 customers is a risk, thus a high factor value is assigned to the user's requests.

Peer comparison: When the user total exfiltration risk score exceeds X times or Y standard deviation from the median peer or from the X percentile user risk score.

The peer group is based on a common role, responsibility, department, ActiveDirectory group and/or LDAP properties. The invention enables to compare exfiltration data scores and trends with peers to detect outliers.
The user's sensitive exfiltration values, volume, variety and velocity scores are continuously compared to the user's peers. Any deviation from the peer behavior is automatically alerted to the security administrators for investigation.

External security systems such as IAM (Identity Access Management)—providing a notification when a user have just resigned and is leaving to a competitor, or when a devices has been infected by malware—thus a high factor value is assigned to the user's requests.

In stage 3, the above is preferably compared to the user's own history of data behavior. In stage 4, the above is preferably compared to the historical behavior of a group, such as the user's peers. In stage 5, the above is preferably compared to one or more policies. In stage 6, these comparisons determine whether the request is allowed to proceed.

It will be appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination. It will also be appreciated by persons skilled in the art that the present invention is not limited by what has been particularly shown and described hereinabove. Rather the scope of the invention is defined only by the claims which follow.

What is claimed is:

1. A method for detecting sensitive data in a transaction, in a system comprising a user application, an application server and a data source in communication through a computer network, the application server operating a real time program, the method comprising:
a. Determining a policy for permitted data transactions, wherein said policy is determined according to a data lineage for data transactions between the user application, the application server and the data source;
b. Injecting code to the real time program according to said policy;
c. Detecting a data request from the user application and/or a data response from the data source by said injected code;
d. Determining a score for data in said data request and/or said data response by said injected code; and
e. Determining whether said data request and/or said data response is to be blocked by said injected code.

2. The method of claim 1, wherein said data request includes a data request from the user application and a data request from the application server, and wherein said data response includes a data response from the data source and a data response from the application server, wherein only said data request and said data response are detected.

3. The method of claim 2, further comprising recording said score for said data response and for said data request; and auditing interactions according to said recording.

4. The method of claim 3, wherein said auditing is performed with regard to a particular user identifier for the user application.

5. The method of claim 1, further comprising blocking said data request and/or said data response by said injected code, wherein said blocking comprises one or more of preventing said data request and/or said data response from proceeding, alerting or notifying appropriate administrators, or redacting/anonymizing/masking/encrypting/decrypting/tokenizing/de-tokenizing some or all of the data in one or both of said data request and/or said data response.

6. The method of claim 1, wherein said determining is performed in real time.

7. The method of claim 1, for operation in a system including a Security Information Event Management System (SIEM), the method further comprising sending whether said data request and/or said data response may proceed to said SIEM as a triggering event.

8. The method of claim 1, wherein said determining said score is determined according to a 4V model, comprising determining a value of data, a velocity of data, a variety of data and/or a volume of data being transmitted in said data request and/or said data response; and determining said score according to said value, said velocity, said variety and/or said volume.

9. The method of claim 8, comprising determining said score according to all of said value, said velocity, said variety and said volume.

10. The method of claim 9, wherein said determining said score according to said value, said velocity, said variety and said volume further comprises comparing each of said value, said velocity, said variety and said volume to historical values for an identified user operating said user application.

11. The method of claim 10, wherein said determining said score according to said value, said velocity, said variety and said volume further comprises comparing each of said value, said velocity, said variety and said volume to historical values for a group of identified users operating said user application.

12. The method of claim 8, further comprising applying a logarithmic scale to data analyses performed according to said 4V model.

13. A method for detecting sensitive data in a transaction, in a system comprising a user application, an application server and a data source in communication through a computer network, the application server operating a real time program and an application agent, the method comprising:
a. Determining a policy for permitted data transactions, wherein said policy is determined according to a data lineage for data transactions between the user application, the application server and the data source;
b. Determining one or more permitted data transaction parameters for said application agent according to said policy;
c. Detecting a data request from the user application and/or a data response from the data source by said application agent;
d. Determining a score for data in said data request and/or said data response by said application agent; and
e. Determining whether said data request and/or said data response may proceed by said application agent.

14. A method for detecting sensitive data in a transaction, in a system comprising a user application, an application server, a central policy manager and a data source in communication through a computer network, the application server operating a real time program, the method comprising:
a. Determining a policy for permitted data transactions by said central policy manager, wherein said policy is determined according to a data lineage for data transactions between the user application, the application server and the data source;
b. Detecting a data request from the user application and/or a data response from the data source by said central policy manager,
c. Determining a score for data in said data request and/or said data response by said central policy manager; and
d. Determining whether said data request and/or said data response may proceed by said central policy manager.

15. A system for detecting sensitive data, comprising:
a. A user computer;
b. A user application operated by said user computer;
c. An application server;
d. A real time program operated by said application server
e. A data source;
f. A central policy management server for setting and managing one or more policies for governing data transactions in the system;
g. A computer network for communication between said user application, said application server and said data source, including a data request from the user application and a data response from the data source;
h. A policy to code generator for generating injectable code to be injected at the real time program operated by the application server and/or user application, according to said policies of said central policy management server, for detecting sensitive information.

16. The system of claim 15, wherein the application server comprises a plurality of application servers and wherein said policy to code generator generates a plurality of sets of injectable code to be injected at said plurality of real time programs.

17. The system of claim 16, wherein each set of injectable code injects a marker for detecting from which real time program at which application server sensitive information is detected.

18. The system of claim 15, further comprising an agent operated by said user computer for obtaining contextual information related to said sensitive information and for relaying such contextual information to said central policy management server.

19. The system of claim 15, further comprising an agent operated by said application server for filtering incoming requests from said user application against a large array of values to detect incoming requests that are not allowed.

20. The system of claim 15, wherein said central policy management server, upon reviewing an incoming request from said user application, determines that at least one value of sensitive information provided by said incoming request, or provided in response to said incoming request, is to be masked.

21. The system of claim 20, wherein said masking comprises performing a dynamic mask to replace or delete one or more request information or variables, and/or to perform one of the following: encrypt/decrypt, tokenize/detokenize, hide, redact, delay or block the sensitive-data-flows and high value transactions of end-users and/or external program interface (API calls).

22. The system of claim 15, wherein said injected code to said user application and/or said real time program operated by said application server, is executed before and/or after sensitive user requests and data requests to audit and monitor data flows and sensitive transactions.

23. The system of claim 22, wherein said injected code collects at least one of the following data upon execution: end-user name, the user request, the user and/or data request variables, the data request, the result set returned from the data source to the application if available, and/or the user response if available.

24. The system of claim 22, wherein said injected code determines when to execute according to a Post-Build process that scans the source or binary code during development time and injects the relevant code into the source or binary, before it is being deployed; as a post build process, where a virtual machine transforms/instruments the binary code before it is being loaded into memory and before it is being executed by the virtual machine; by injecting code into application files in the filesystem before it is being loaded and executed at runtime; or by changing the source code of the application, by adding program calls to a central server for sending event context and receiving changes to the variables and code executed by the application.

25. The system of claim 22, wherein said injected code is added to user applications and/or applications run by said application server in which program code can be instrumented, as well as on program code that cannot be instrumented by using code changes in the application.
